(19) United States
(12) Patent Application Publication
(10) Pub. No.: US 2002/0000764 A1
(43) Pub. Date: Jan. 3, 2002

(54) Lighting unit for a lamp, particularly discharge lamps

(75) Inventors: Lars Bewig, Bad Gandersheim (DE); Thomas Kupper, Bad Gandersheim (DE); Wolfram Maring, Bad Gandersheim (DE); Christoph Moelle, Bad Gandersheim (DE)

Correspondence Address: Charles N.J. Ruggiero, Esq., Ohlandt, Greeley, Ruggiero & Perle, L.L.P., One Landmark Square, 10th Floor, Stamford, CT, 06901-2682, US

(73) Assignee: Schott Glas

(21) Appl. No.: 09/866,578

(22) Filed: May 25, 2001

(30) Foreign Application Priority Data
May 26, 2000 (DE) 100 26 101.9

(51) Int. Cl. H01K 1/26

(52) U.S. Cl. 313/110

(57) ABSTRACT

The invention concerns a lighting unit, particularly a gas-discharge lighting unit having a hollow body and metal electrodes within the hollow body. A wall is provided with a coating which has heat-reflecting or infrared radiation-reflecting properties.

### FIELD OF THE INVENTION

The invention concerns a lighting unit for a lamp. It particularly involves a lighting unit for discharge lamps, which is placed under high internal pressure and operates according to the gas-discharge principle.

### BACKGROUND OF THE INVENTION

Lighting units of the named type presently have a broad application. An important field of application is in lamps for automobiles, for example, headlights. A widely used field of application is also in stores, in which the named lighting units are used, in fact, in combination with reflectors. Other fields of application include video projection systems and stage lighting-spotlights.

Such lighting units comprise a hollow glass unit and two metal electrodes enclosed therein.

The energy introduced into the lighting unit is converted only partially to light. A considerable portion is given off to the environment in the form of heat. This is highly undesired for two reasons: First of all, the energy component converted to heat is not available for generating light. Secondly, components that surround the lighting unit are heated and can be damaged by this heating. In order to reduce or to avoid the disadvantageous effects of heating, special measures must be taken. Thus, for example, the surrounding parts of a lamp must be at a sufficiently great distance from the lighting unit, and must be appropriately dimensioned, so that they withstand heat stresses, or are cooled. All of these measures require additional expenditure, which increases the manufacturing costs of systems.

Halogen lighting units of the named type with infrared reflecting coating are known. Here one persues the goal of extracting as much light energy as possible from the energy introduced into the lighting unit by back-reflection of the infrared radiation onto the filament. This principle, however, operates only in the case of thermal radiators such as black-body radiators, but not in the case of arc lamps or discharge lamps.

### SUMMARY OF THE INVENTION

The object of the invention is based on creating a lighting unit of the named type, which is configured first of all to prevent or at least to reduce the disadvantageous effects of the quantity of heat that arises during operation, and optionally also to increase the luminosity factor as well as to influence the spectral distribution.

This object is solved by the features of the present invention.

The inventors have proceeded by an entirely new route. The quantity of heat given off by the lighting unit to the outside is very greatly reduced by coating the hollow body of the lighting unit with a heat-reflecting layer. The reduction can reach such an extent that additional measures, such as a cooling, special dimensioning of the surrounding components of the lamp belonging to it or maintaining a particularly great distance between such components and the lighting unit are superfluous.

It could thus be stated that the invention represents the reverse of the cold light reflection principle, since the lamp or its components that surround the lighting unit remain cold.

The practical advantageous effects of the invention are, for example, the following: The surrounding components need not absolutely be made of glass, as in the prior art. Suitable plastics can be used. The invention operates particularly advantageously in the case of projector lamps, in which the ventilation that is associated with an intense generation of noise can be throttled or completely eliminated. Possibilities for using the lighting units of the named type are opened up, which previously were not possible due to the evolution of heat.

A very basic viewpoint is the following: If the heat evolved in operating the lighting unit reflects inwardly at the layer according to the invention, then the additional heating of the gas in the lighting unit acts positively on the luminosity factor as well as the continuity of the light spectrum.

A dielectric stack of layers is particularly well suitable as a filter layer. The following material pairs are suitable:

SiO₂-TiO₂

SiO₂-Nb₂O₅

SiO₂-Ta₂O₅

It can generally be said that combinations of high-refracting and low-refracting materials are well suitable.

The usual methods are used for introducing the layer, for example, PICVD (Plasma Impulse Chemical Vapor Deposition).

1. Lighting unit, particularly gas-discharge lighting unit;
1.1 with a hollow body;
1.2 with metal electrodes enclosed therein;
1.3 the wall is provided with a coating;
1.4 the coating has heat-reflecting or infrared radiation-reflecting properties.

2. Lighting unit according to claim 1, further characterized in that the hollow unit is comprised of glass.

3. Lighting unit according to claim 1 or 2, further characterized in that the coating is found on the inner surface of the wall.

4. Lighting unit according to claim 1 or 2, further characterized in that the coating is found on the outer surface of the wall.

5. Lighting unit according to one of claims 1 to 4, further characterized in that the coating comprises a dielectric stack of layers of high-refracting and low-refracting materials.

6. Device according to one of claims 1 to 6*, further characterized in that the coating is introduced according to the PICVD process.
